(19) United States
(12) Patent Application Publication
(10) Pub. No.: US 2004/0039783 A1
(43) Pub. Date: Feb. 26, 2004

(54) Multimedia messaging system and method for securely transmitting messages

(76) Inventors: Chi Chung Su, Tu-chen (TW); PengCheng Lee, Shenzhen (CN); WeiHua Guan, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/328,580

(22) Filed: Dec. 23, 2002

(30) Foreign Application Priority Data
Aug. 20, 2002 (TW) 91118742

(51) Int. Cl. G06F 15/16

(52) U.S. Cl. 709/206

(57) ABSTRACT

A multimedia messaging system and method for transmitting messages securely and quickly by sending alert signals in advance. The system includes a plurality of message providers (1), an alert server (2), and a plurality of message receivers (4). The message providers and the message receivers are linked to the alert server via a communication network (3). The alert server includes a first database (20), an application (21), and a second database (22). The first database receives various messages provided by the message providers. The application generates an alert signal for each message, and sends the generated alert signals and corresponding messages in that order to corresponding message receivers. The message receivers receive the alert signals and corresponding messages in that order, and send respective receipts to the alert server in corresponding order. The second database stores messages that have accompanying alert signals.

### BACKGROUND OF THE INVENTION

1. Field of the Invention

The present invention relates to a system and method for transmitting messages, and particularly to a system and method for sending alert signals before transmitting the messages.

2. Background of the Invention

With the development of the concept of e-enterprises, efficiency and security of information transmission is becoming more and more important for an enterprise to operate smoothly and efficiently. Enterprises are constantly endeavoring to build information transmission systems that more conveniently exchange information between their employees. Many systems and methods have already been developed for transmission of information. For example, U.S. Pat. No. 5,510,907 discloses a facsimile apparatus having an urgent message transmission function. This allows an operator to send an urgent message by selecting one of pre-recorded destination stations according to the nature of the urgency, and in accordance with a selected message transmission mode.

Although the apparatus disclosed in the above-mentioned patent can transmit urgent messages without undue delay, it does not ensure that a receiver can receive the message at the time that the message is transmitted. A system and method is needed for promptly transmitting an urgent message and ensuring that a receiver can timely receive the message.

### SUMMARY OF THE INVENTION

Accordingly, an object of the present invention is to provide a multimedia messaging system and method for transmitting messages between message providers and message receivers.

Another object of the present invention is to provide a multimedia messaging system and method for sending alert signals to message receivers before sending messages to the receivers.

In order to accomplish the above-mentioned objects, the present invention provides a multimedia messaging system and method for transmitting messages securely and quickly by sending alert signals in advance. A preferred embodiment of the system comprises a plurality of message providers, an alert server, and a plurality of message receivers. The message providers and the message receivers are linked to the alert server via a communication network. The message providers provide various messages. The alert server processes and sends the messages, and comprises: a first database for receiving and caching the messages; an application for retrieving the messages from the first database, generating an alert signal for each message, and sending alert signals and corresponding messages to the message receivers; and a second database for storing messages that have accompanying alert signals. The message receivers receive the alert signals and corresponding messages, and thereupon send receipts to the alert server.

A preferred embodiment of the multimedia messaging method comprises the following steps: (i) receiving and caching various messages in a first database, the messages being provided by a plurality of message providers; (ii) retrieving the messages from the first database, and sequencing the messages based on a sequence provided by each message provider and on a degree of urgency of each message; (iii) generating an alert signal and an alert deadline for each message, and caching messages that have accompanying alert signals in a second database; (iv) sending alert signals to all corresponding message receivers within corresponding alert deadlines; (v) sending messages to all corresponding message receivers within a predefined time limit if the message receivers have received the alert signals.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of infrastructure of a multimedia messaging system for sending messages in accordance with a preferred embodiment of the present invention;

FIG. 2 is a schematic diagram of infrastructure of an application in an alert server of the system of FIG. 1;

FIG. 3 is a schematic diagram of infrastructure of an alert module of the application shown in FIG. 2;

FIG. 4 is an exemplary flowchart of sending messages in accordance with a preferred embodiment of the present invention; and

FIG. 5 is a flowchart of generating alert signals in accordance with a preferred embodiment of the present invention.

### DETAILED DESCRIPTION OF PREFERRED EMBODIMENTS OF THE INVENTION

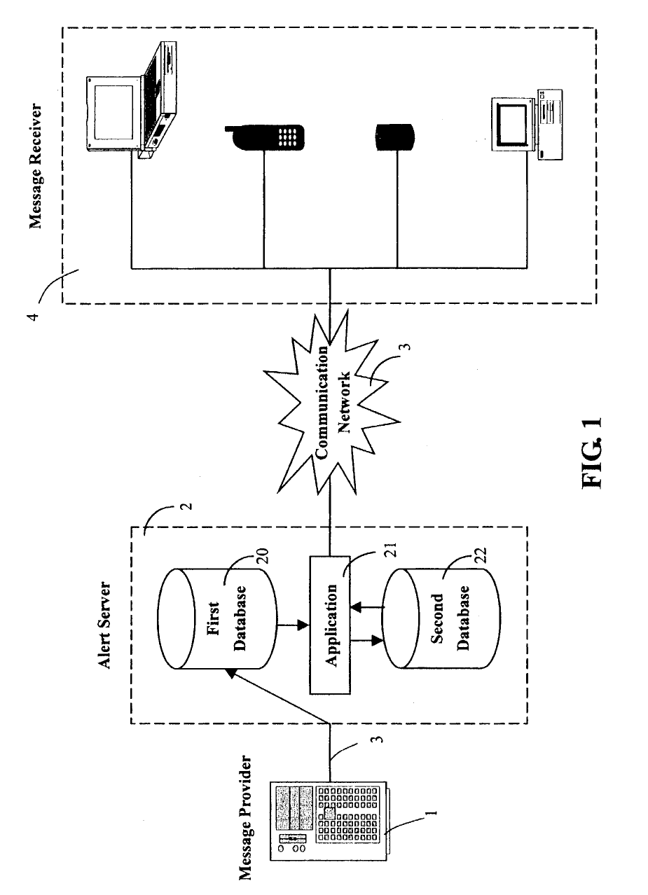

FIG. 1 is a schematic diagram of infrastructure of a multimedia messaging system for sending messages in accordance with a preferred embodiment of the present invention. The multimedia messaging system comprises a plurality of message providers 1 (only one shown), an alert server 2, and a plurality of message receivers 4. The message providers 1 and the message receivers 4 are linked to the alert server 2 via a communication network 3. The message providers 1 provide various messages that are to be transmitted to the message receivers 4. Such messages may include short messages, E-mail, images, and even audio messages. The alert server 2 is used for generating an alert signal for each message, and for transmitting each message to a corresponding message receiver 4. The message receivers 4 receive alert signals and messages, and return receipts to the alert server 2 after receiving the alert signals and messages. A message receiver 4 may, for example, be a laptop computer, a mobile phone, a personal digital assistant (PDA), or a desktop computer.

The alert server 2 comprises a first database 20, an application 21, and a second database 22. The first database 20 is used for receiving and caching various messages provided by the message providers 1. The application 21 is used for retrieving the various messages from the first database 20, for generating an alert signal for each of the various messages, and for sending each generated alert signal and corresponding message to at least one corresponding message receiver 4. The second database 22 is used for caching messages that have accompanying generated alert signals.

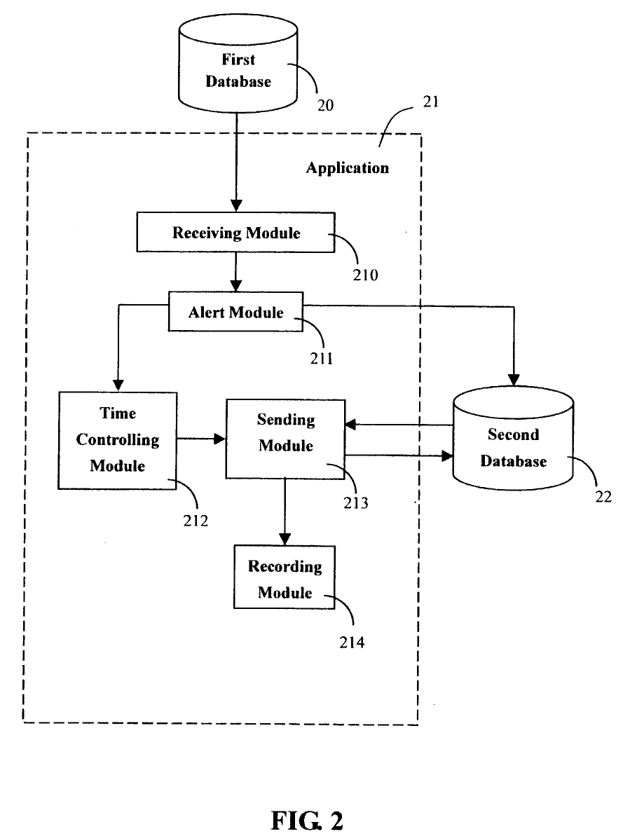

FIG. 2 is a schematic diagram of infrastructure of the application 21 of the alert server 2. The application 21 comprises a receiving module 210, an alert module 211, a time controlling module 212, a sending module 213, and a recording module 214. The receiving module 210 is used for retrieving various messages from the first database 20, and for sequencing the various messages. Sequencing is based on a sequence provided by each message provider 1 and on a degree of urgency of each message. The alert module 211 is used for generating an alert signal and an accompanying alert deadline for each message, based on a classification of the message and on other criteria relating to the message. The classification of a message may be short message, E-mail, image, or audio message. Said other criteria comprise message receiver 4, and degree of urgency of each message. The alert module 211 also sends generated alert signals to corresponding message receivers 4, and receives alert signal receipts returned by the corresponding message receivers 4. An alert signal receipt is a kind of return receipt sent by a message receiver 4 after it has received an alert signal. The time controlling module 212 is used for determining whether a period of time actually required for successful sending of a message exceeds a predefined time limit. The sending module 213 is used for sending messages to the message receivers 4. The recording module 214 is used for recording information related to procedures for sending of messages. Such information comprises message ID, classification of message, degree of urgency of message, message receiver, and confirmation of receipt of message. The second database 22 is linked with the alert module 211, and stores messages that have accompanying generated alert signals.

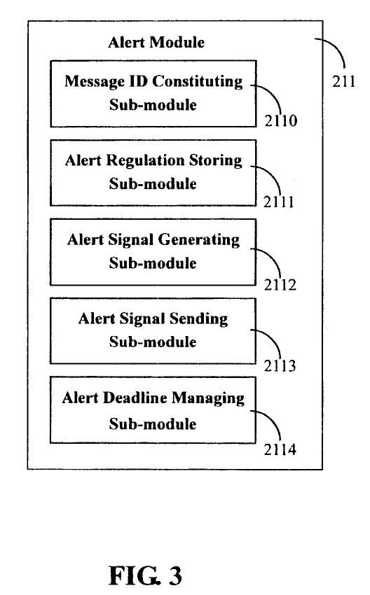

FIG. 3 is a schematic diagram of infrastructure of the alert module 211 of the application 21. The alert module 211 comprises a message ID constituting sub-module 2110, an alert regulation storing sub-module 2111, an alert signal generating sub-module 2112, an alert signal sending sub-module 2113, and an alert deadline controlling sub-module 2114. The message ID constituting sub-module 2110 is used for constituting an ID for each message retrieved from the first database 20. The alert regulation storing sub-module 2111 is used for storing a predefined regulation. The alert signal generating sub-module 2112 is used for generating an alert signal for the message according to the predefined regulation, and based on a classification of the message and on other criteria relating to the message. The alert signal sending sub-module 2113 is used for sending alert signals to the message receivers 4. The alert deadline managing sub-module 2114 is used for generating an alert deadline for each alert signal according to the predefined regulation, and based on the classification of the message and on other criteria relating to the message. The alert deadline managing sub-module 2114 is also used for determining whether a message receiver 4 receives an alert signal sent by the alert sending sub-module 2113 prior to the corresponding alert deadline.

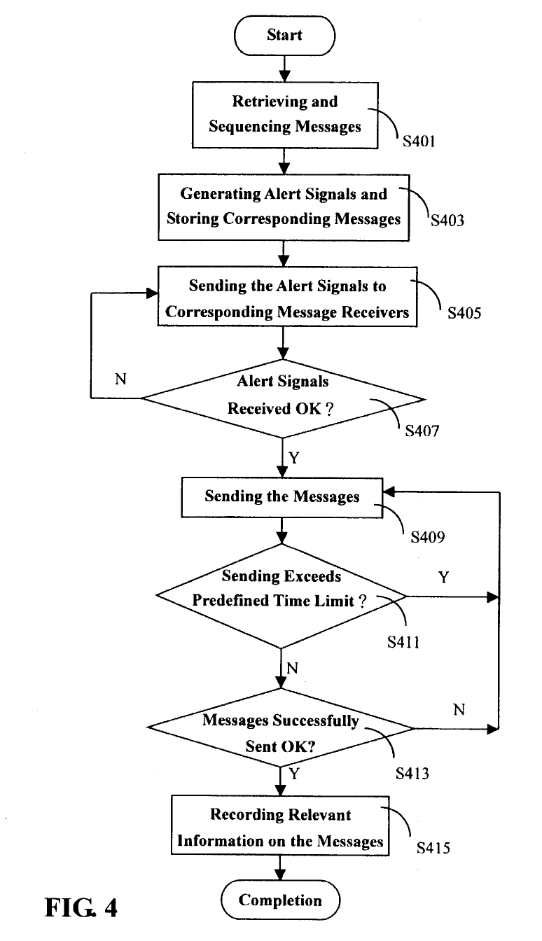

FIG. 4 is an exemplary flowchart of sending messages in accordance with a preferred embodiment of the present invention. At step S401, the receiving module 210 retrieves various messages from the first database 20, and sequences the messages based on a sequence provided by each corresponding message provider 1 and on a degree of urgency of each message. At step S403, the alert module 211 generates an alert signal and alert deadline for each message. The second database 22 stores messages that have accompanying generated alert signals. At step S405, the alert module 211 sends the generated alert signals to corresponding message receivers 4. At step S407, the alert deadline managing sub-module 2114 ascertains whether the alert module 211 has received alert signal receipts from all corresponding message receivers 4 within the corresponding alert deadlines. If the alert module 211 has not received all corresponding alert signal receipts for a particular message, the procedure returns to step S405 so that the corresponding alert signal is sent once again to all corresponding message receivers 4. If the alert module 211 has received all alert signal receipts from all corresponding message receivers 4, at step S409, the sending module 213 sends corresponding messages stored in the second database 22 to the corresponding message receivers 4. During this sending procedure, at step S411, the time controlling module 212 determines whether a period of time actually required for sending each message exceeds the predefined time limit for successful sending of the message. In the preferred embodiment, each message has the same predefined time limit. If the period of time actually required for sending a particular message exceeds the predefined time limit, the sending procedure for that message stops, the message is stored in the second database 22 again, and the message is re-sequenced such that it will be sent again only after one or more other messages are sent. That is, the message returns to step S409. If the period of time actually required for sending a particular message does not exceed the predefined time limit, at step S413, the sending module 213 determines whether all corresponding message receivers 4 have received the message within the predefined time limit. That is, whether the message has been successfully sent within the predefined time limit. This is done by the sending module 213 determining whether it has received message receipts from all corresponding message receivers 4 within the predefined time limit. A message receipt is a kind of return receipt sent by a message receiver 4 after it has received a message. If a particular message has not been successfully sent within the predefined time limit, the message is stored in the second database 22 again, and the message is re-sequenced such that it will be sent again only after one or more other messages are sent. That is, the message returns to step S409. At step S415, when each message has been successfully sent within the predefined time limit, the recording module 214 records relevant information on the message. Such information comprises an ID of the message, classification of the message, degree of urgency of the message, receiver(s) of the message, and message receipt(s) returned by corresponding message receiver(s) 4.

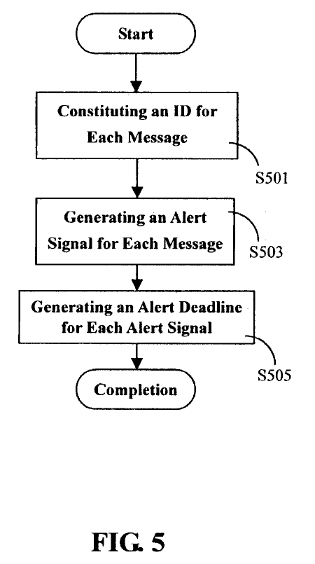

FIG. 5 is a flowchart of generating alert signals in accordance with a preferred embodiment of the present invention. At step S501, the message ID constituting sub-module 2110 constitutes an ID for each message retrieved from the first database 20. At step S503, the alert signal generating sub-module 2112 generates an alert signal for the each message according to the predefined regulation in the alert regulation storing sub-module 2112, and based on a classification of the message and on other criteria relating to the message. At step S505, the alert deadline managing sub-module 2114 generates an alert deadline for each alert signal according to the predefined regulation, and based on the classification of the message and on other criteria relating to the message.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A multimedia messaging system comprising at least one message provider, an alert server, and at least one message receiver, wherein:
the at least one message provider provides various messages;
the alert server is for processing and sending the messages, and comprises:
a first database for receiving and caching the messages;
an application for retrieving the messages from the first database, generating an alert signal for each of the messages, and sending the alert signals and corresponding messages to at least one message receiver; and
a second database for storing messages that have accompanying alert signals; and
the at least one message receiver receives one or more alert signals and corresponding messages, and sends receipts to the alert server after receiving the one or more alert signals and corresponding messages.

2. The multimedia messaging system as claimed in claim 1, wherein the messages include short messages, E-mail, audio messages, and video messages.

3. The multimedia messaging system as claimed in claim 1, wherein the at least one message receiver comprises any one or more of a laptop computer, a mobile phone, a personal digital assistant, and a desktop computer.

4. The multimedia messaging system as claimed in claim 1, wherein the application comprises a receiving module for retrieving the messages cached in the first database, and for sequencing the messages based on a sequence provided by each of the message providers and on a degree of urgency of each of the messages.

5. The multimedia messaging system as claimed in claim 4, wherein the application comprises an alert module for generating an alert signal and an alert deadline for each of the messages based on a classification of the message and on other criteria relating to the message, for sending the alert signal to at least one message receiver, and for receiving a receipt sent by said at least one message receiver.

6. The multimedia messaging system as claimed in claim 5, wherein the other criteria relating to the message comprise at least one identity of said at least one message receiver, and a degree of urgency of the message.

7. The multimedia messaging system as claimed in claim 5, wherein the alert module comprises a message ID constituting sub-module for constituting an ID for each of the messages.

8. The multimedia messaging system as claimed in claim 5, wherein the alert module further comprises an alert regulation storing sub-module for storing a predefined alert regulation for constituting an alert signal and an alert deadline.

9. The multimedia messaging system as claimed in claim 5, wherein the alert module further comprises an alert signal generating sub-module for generating an alert signal for each of the messages.

10. The multimedia messaging system as claimed in claim 5, wherein the alert module further comprises an alert signal sending sub-module for sending an alert message to said at least one message receiver.

11. The multimedia messaging system as claimed in claim 5, wherein the alert module further comprises an alert deadline managing sub-module for generating an alert deadline for each of the alert signals, and for determining whether said at least one message receiver has received an alert signal prior to an accompanying alert deadline of the alert signal.

12. The multimedia messaging system as claimed in claim 1, wherein the application comprises a time controlling module for determining whether a period of time required for sending a message exceeds a predetermined time limit.

13. The multimedia messaging system as claimed in claim 5, wherein the application comprises a sending module for sending a message to said at least one message receiver.

14. The multimedia messaging system as claimed in claim 5, wherein the application comprises a recording module for recording information related to procedures for sending of messages, such information comprising message ID, classification of message, degree of urgency of message, message receiver, and confirmation of receipt of message.

15. A multimedia messaging method comprising the steps of:
(a) receiving and caching various messages in a first database, the messages being provided by at least one message provider;
(b) retrieving the messages from the first database, and sequencing the messages based on a sequence provided by the at least one message provider and on a degree of urgency of each of the messages;
(c) generating an alert signal and an alert deadline for each of the messages, and caching each of the messages that has an accompanying alert signal in a second database;
(d) sending an alert signal to at least one message receiver within the corresponding alert deadline; and
(e) sending a corresponding message to said at least one message receiver within a predefined time limit if said at least one message receiver has received the alert signal.

16. The multimedia messaging method as claimed in claim 15, wherein step (b) further comprises the step of constituting an ID for each of the messages.

17. The multimedia messaging method as claimed in claim 15, wherein step (d) further comprises the step of:
sending the alert signal again to said at least one message receiver if said at least one message receiver has not received the alert signal within the corresponding alert deadline.

18. The multimedia messaging method as claimed in claim 15, wherein step (e) further comprises the step of:
storing the corresponding message in the second database for repeat sending if a time required for sending the message exceeds a predefined time limit.

19. The multimedia messaging method as claimed in claim 15, wherein the step (e) further comprises the step of:
storing the corresponding message in the second database for repeat sending if the message is not successfully sent within the predefined time limit.

20. The multimedia messaging method as claimed in claim 15, further comprising the step of:
recording a message ID, classification of message, message receiver, degree of urgency of message, and confirmation of receipt of message.

21. A multimedia messaging method comprising the steps of:
(a) receiving and caching various messages in a database, the messages being provided by at least one message provider;
(b) retrieving the messages from the first database, and sequencing the messages based on a degree of urgency of each of the messages;
(c) generating an alert signal and an alert deadline for each of the urgent messages, and caching each of the urgent messages that has the corresponding alert signal;
(d) sending the alert signal to the at least one message receiver within the corresponding alert deadline; and
(e) confirming whether said alert signal is received successfully or not, and
(f) sending the corresponding message to said at least one message receiver if yes, or re-sending said alert signal if not.

22. The method as claimed in claim 21, further after step (f) including steps of:
(g) confirming whether said corresponding message is received successfully or not; and
(h) re-sending the corresponding message to said at least one message receiver if not, or repeating all the steps for other successive sequenced messages, individually.
